(19) United States
(12) Patent Application Publication
(10) Pub. No.: US 2009/0273828 A1
(43) Pub. Date: Nov. 5, 2009

(54) High average power ultra-short pulsed laser based on an optical amplification system

(75) Inventors: Robert G. Waarts, Los Altos, CA (US); Timothy J. Booth, West Melbourne, FL (US)

Correspondence Address: CARR & FERRELL LLP, 2200 GENG ROAD, PALO ALTO, CA, 94303, US

(73) Assignee: Raydiance, Inc.

(21) Appl. No.: 12/150,887

(22) Filed: Apr. 30, 2008

(51) Int. Cl. H01S 3/00

(52) U.S. Cl. 359/341.1; 359/349; 359/348

(57) ABSTRACT

The present invention includes an apparatus and the method to scale the average power from high power ultra-short pulsed lasers, while at the same time addressing the issue of effective beam delivery and ablation, by use of an optical amplification system.

### BACKGROUND OF THE INVENTION

1. Technical Field

The present invention relates generally to the field of light amplification and, particularly to systems useful in athermal ablation.

2. Description of Related Art

An ultra-short pulse (USP) laser emits pulses with a temporal pulse length in the range of picoseconds (psec, 10⁻¹² seconds) to femtoseconds (fsec, 10⁻¹⁵ seconds) resulting in a very high electric field for a short duration of time. Typical techniques for generating these ultra-short pulses are well known. Generally, large systems, such as Ti:Sapphire, are used for generating ultra-short pulses.

USP phenomena were first observed in the 1970's. It was discovered that mode-locking a broad-spectrum laser could produce ultra-short pulses. As produced, an ultra-short pulse has significantly lower power compared to optical pulses having greater temporal lengths. When high-power, ultra-short pulses are desired, the pulses are intentionally lengthened temporally, or chirped, prior to amplification to avoid damaging system components. This process is referred to as chirped pulse amplification (CPA). Subsequent to chirping and amplification, the pulse is compressed temporally to obtain both high peak power and ultra-short pulse duration.

Generally, ablation refers to removal of material, for example, by an erosive process. Lasers can be implemented to ablate material in a selective manner. Two broad classes of laser ablation are thermal and athermal. Thermal ablation is dependent of thermal effects, such as melting. Athermal ablation can occur when an ultra-short pulse is focused on a material as a result of the high electric fields associated with the ultra-short pulse. There are several advantages of athermal ablation over other means of material removal. Compared to conventional mechanical machining, athermal ablation permits more accurate removal without mechanical damage of surrounding material. Conventional laser machining (e.g., thermal ablation), which uses continuous wave (cw) or long-pulsed lasers (e.g., pulse durations greater than roughly 1 nsec, or nanoseconds, 10⁻⁹ seconds) can be more precise and flexible as compared to mechanical machining, but can damage surrounding materials. Material removal by athermal ablation is especially useful for medical purposes, either in-vivo or on the outside surface (e.g., skin or tooth), as it is generally painless.

Despite the advantages of athermal ablation, there is a trade-off between average pulse power and pulse quality. Higher pulse powers enable higher material removal rates, but are subject to pulse aberrations and distortions. Conversely, lower pulse powers result in low material removal rates that render the technique impractical for most applications.

### SUMMARY OF THE INVENTION

In one embodiment, a system may comprise an optical pulse stretcher, an optical splitter, an optical amplifier, and an optical pulse compressor. The optical pulse stretcher may be configured to chirp an optical pulse to produce a chirped optical pulse. The optical splitter may be configured to optically split the chirped optical pulse to produce a plurality of split optical pulses. The optical amplifier may be configured to optically amplify one of the plurality of split optical pulses to produce an optically amplified split optical pulse. The optical pulse compressor may be configured to compress the optically amplified split optical pulse to produce a compressed optically amplified split optical pulse.

In another embodiment, a method may comprise optically splitting a chirped optical pulse to produce a plurality of split optical pulses, optically amplifying one of the plurality of split optical pulses to produce an optically amplified split optical pulse, and optically compressing the optically amplified split optical pulse to produce a compressed optically amplified split optical pulse.

### BRIEF DESCRIPTION OF THE DRAWINGS

FIG. 1 is a block diagram illustrating an ultra-short pulse laser system, according to the prior art.

FIG. 2 is a block diagram illustrating one embodiment of an optical amplification system, according to various embodiments of the invention.

FIG. 3 is a block diagram illustrating another embodiment of an optical amplification system, according to various embodiments of the invention.

FIG. 4 is a block diagram illustrating yet another embodiment of an optical amplification system including polarization combination, according to various embodiments of the invention.

FIG. 5 is a diagram illustrating a variety of delivery system configurations, according to various embodiments of the invention.

FIG. 6 is a flowchart showing an exemplary process for providing a compressed optically amplified split optical pulse, according to various embodiments of the invention.

### DETAILED DESCRIPTION OF THE INVENTION

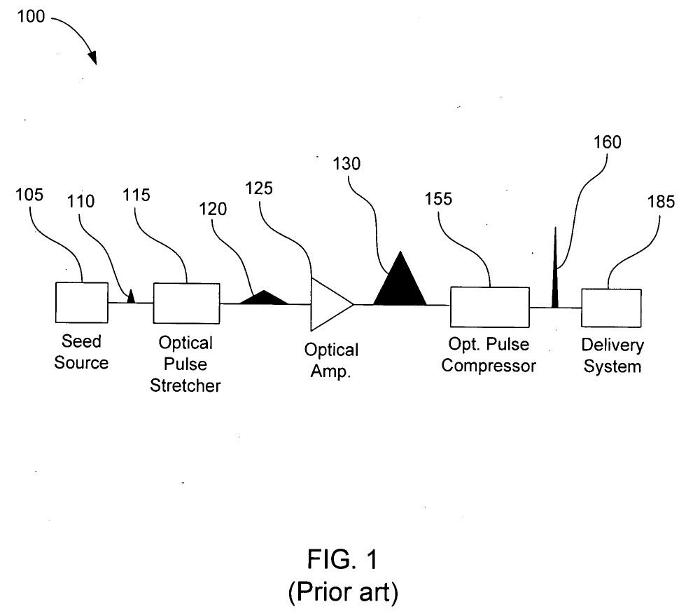

An ultra-short pulse (USP) laser system emits optical pulses resulting in a very high electric field for an ultra-short short period of time. In this context, “ultra-short” refers to durations in the range of picoseconds (psec, 10⁻¹² seconds) to femtoseconds (fsec, 10⁻¹⁵ seconds). Although the peak power of a USP may be high, the average power contained by the USP may be relatively low, as a result of the pulse duration being ultra-short. FIG. 1 is a block diagram illustrating a typical USP laser system 100, according to various embodiments of the prior art. A seed source 105 can be any light source capable of generating an optical pulse 110 with characteristics of an ultra-short pulse. Light sources with this capability may include, for example, fiber mode-locked lasers, gas lasers (e.g., helium-neon, argon, and krypton), chemical lasers (e.g., hydrogen fluoride and deuterium fluoride), dye lasers, metal vapor lasers (e.g., helium cadmium metal vapor), solid state lasers (e.g., titanium sapphire and neodymium yttrium aluminum garnet), and semiconductor lasers (e.g., gallium nitride and aluminum gallium arsenide).

As discussed herein, the optical pulse 110 generated by the seed source 105 may have a small average power and require subsequent amplification for certain applications. Prior to amplification, the pulses may be temporally stretched, or “chirped,” by an optical pulse stretcher 115. Chirping the pulse reduces the peak power and permits subsequent amplification without damage to the optical amplifiers and other system components. Temporal pulse stretching may be achieved with various grating and/or prism arrangements, although other methods exist and are known in the art. In one embodiment, the optical pulse 110 propagates through a thick slab of glass to be stretched temporally. In another embodiment, the optical pulse stretcher 115 may include an optical fiber.

After a chirped optical pulse 120 is produced by the optical pulse stretcher 115, the chirped optical pulse 120 may be amplified by an optical amplifier 125. The optical amplifier 125 may be a component that amplifies the optical power of the pulse directly without converting it to an electrical signal. According to various embodiments, the optical amplifier 125 may be a single component or include a serial array of amplifiers, where the output of one amplifier is received directly by the input of another amplifier and so on. In other embodiments, the optical amplifier 125 may include any combination of laser amplifiers, optical fiber based optical amplifiers (e.g., doped fiber amplifier), semiconductor optical amplifiers, Raman amplifiers, and/or parametric optical amplifiers.

After an optically amplified chirped optical pulse 130 is produced by the optical amplifier 125, the optically amplified chirped optical pulse 130 may be compressed temporally by an optical pulse compressor 155. Temporal compression of an optical pulse may be achieved using similar approaches as may be used with the optical pulse stretcher 115 (e.g., grating, prism, and/or fiber configuration). According to an exemplary embodiment, a compressed optically amplified optical pulse 160 produced by the optical pulse compressor 155 may have duration similar to the duration of the optical pulse 110 (i.e., ultra-short duration) and with a peak power increased by several orders of magnitude. Finally, a delivery system 185 may receive the compressed optically amplified optical pulse 160 and deliver it to a location. In some embodiments, the delivery system 185 may include, for example, optical fibers, focusing optics, beam modulators, and beam steerers.

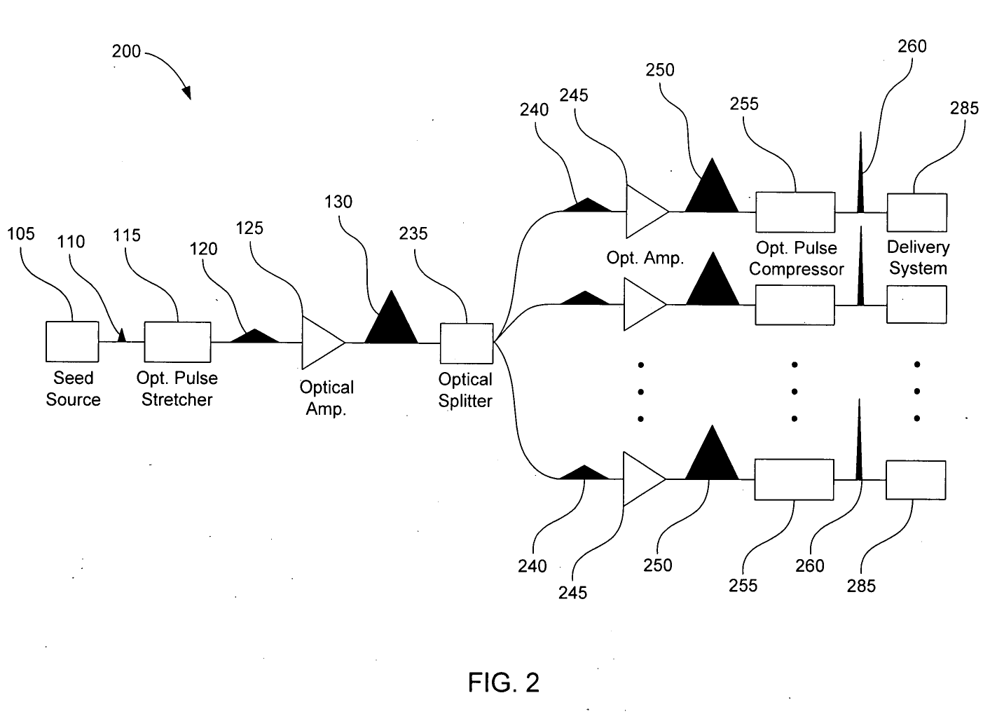

FIG. 2 is a block diagram illustrating one embodiment of an optical amplification system 200, according to various embodiments of the invention. In the optical amplification system 200, the optically amplified chirped optical pulse 130 is split by an optical splitter 235. One skilled in the art will recognize that in some embodiments, the optical amplifier 125 may be omitted from the optical amplification system 200 such that the chirped optical pulse 120 is split by the optical splitter 235, for example, when the chirped optical pulse 120 has sufficient power. According to various embodiments, the optical splitter 235 may include, for example, a fused fiber-based coupler or a beam splitter cube. In another embodiment, the optical splitter 235 may include a series of optical splitters. The optical splitter 235 may divide the optically amplified chirped optical pulse 130 to produce a plurality of split optical pulses 240. Each of the plurality of split optical pulses 240 may have similar duration as the optically amplified chirped optical pulse 130, but with reduced power.

In one alternative embodiment, the optical splitter 235 may be a temporal splitter. The temporal splitter may direct different pulses from a high-repetition pulse train into different fibers. The temporal splitter may result in reduced loss of optical power at the optical splitter 235. One skilled in the art will recognize that in some embodiments, the temporal splitter may comprise an acousto-optic switch or a series of binary switches.

Subsequent to the optically amplified chirped optical pulse 130 being split by the optical splitter 235, each of the plurality of split optical pulses 240 may be received by a separate optical amplifier 245. The optical amplifiers 245 may have any number of physical configurations. The configuration illustrated in FIG. 2 is a linear parallel array. According to some embodiments, the optical amplifiers 245 may be arranged in close proximity to each other. As one skilled in the art will recognize, the optical amplifiers 245 may be arranged in a substantially circular array.

Each of the plurality of split optical pulses 240 may have a reduced peak power relative to that of the optically amplified chirped optical pulse 130. To regain the power lost as a result of splitting, the plurality of split optical pulses 240 may be further amplified. In the embodiment illustrated in FIG. 2, the optical amplifiers 245 may include a plurality of individual optical amplifiers, each being similar to the optical amplifier 125. The optical amplifiers 245 produce at least one optically amplified split optical pulse 250. The optically amplified split optical pulse 250 may have increased peak power and similar duration relative to one of the plurality of split optical pulses 240.

Following amplification by the optical amplifiers 245, the optically amplified split optical pulse 250 may be temporally compressed by an optical pulse compressor 255. In an exemplary embodiment, the optical pulse compressor 255 may include a plurality of individual optical pulse compressors (e.g., similar to the optical pulse compressor 155), each of which may separately receive a pulse. A compressed optically amplified split optical pulse 260 may be produced by the optical pulse compressor 255. The compressed optically amplified split optical pulse 260 may have duration similar to the optical pulse 110, but with much higher peak power. The compressed optically amplified split optical pulse 260 may then be received by a delivery system 285.

The delivery system 285 may include a plurality of independent delivery systems which may each be similar to the delivery system 185. The delivery system 285 may deliver one or more of the compressed optically amplified split optical pulses 260 to at least one location. The delivery system 285 is discussed further herein.

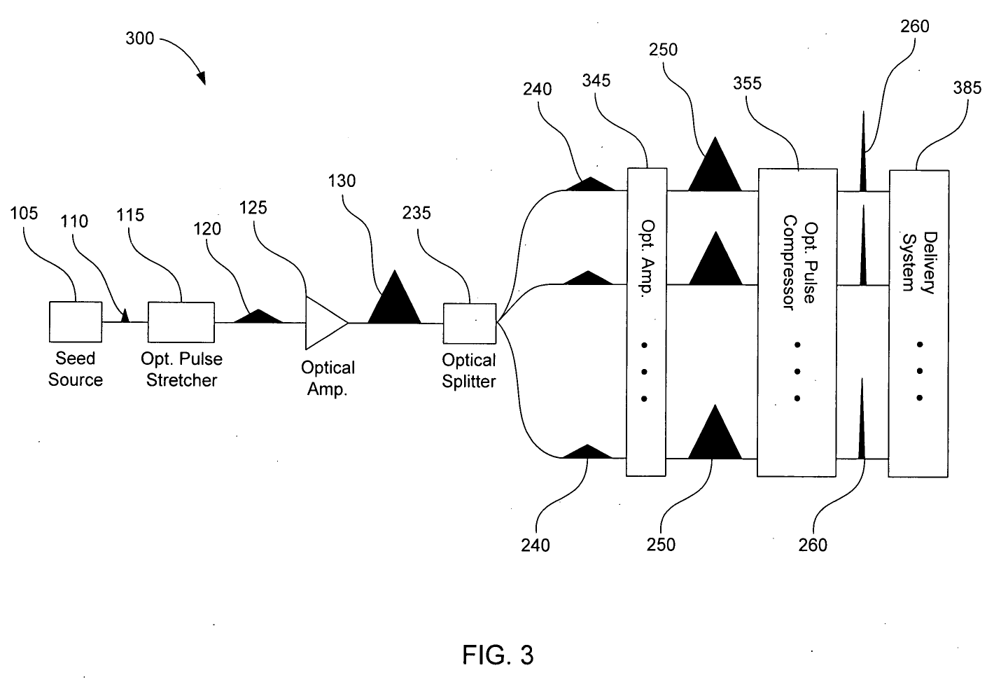

FIG. 3 is a block diagram illustrating another embodiment of an optical amplification system 300, according to various embodiments of the invention. The optical amplification system 300 may operate similarly to the optical amplification system 200, while certain individual components have been substituted for other components (e.g., bulk components) as discussed herein. According to the embodiment shown in FIG. 3, a single optical amplifier 345 has replaced the plurality of optical amplifiers 245 of the optical amplification system 200. According to various embodiments, the optical amplifier 345 may include a single double-clad fiber with multiple cores (e.g., photonic crystal fiber, micro-structured fiber, photonic band gap fiber, holey fiber, and Bragg fiber). In one embodiment, the optical amplifier 345 may include a single bulk amplifier.

Further, in the embodiment illustrated in FIG. 3, a single optical pulse compressor 355 has replaced the plurality of optical pulse compressors 255 of the optical amplification system 200. According to some embodiments, the optical pulse compressor 355 may include a bulk grating compressor. In other embodiments, the optical pulse compressor 355 may include a single volume Bragg grating.

Additionally, in the embodiment illustrated in FIG. 3, a single delivery system 385 has replaced the plurality of delivery systems 285 of the optical amplification system 200. According to various embodiments, the delivery system 385 serves to deliver a plurality of compressed optically amplified split optical pulses to at least one location. The delivery system 385 is discussed further herein.

Various other embodiments at least include substituting or combining the components illustrated in FIG. 2 (e.g., the optical amplifiers 245, the optical pulse compressor 255, and the delivery system 285) with the analogous components illustrated in FIG. 3 (e.g., the optical amplifier 345, optical pulse compressor 355, and delivery system 385). For example, those skilled in the art would appreciate that an optical amplification system which included the optical amplifiers 245, the optical pulse compressor 355, and the delivery system 285 would embody the present invention. As mentioned herein, any combination described herein may also include integration into a planar waveguide system.

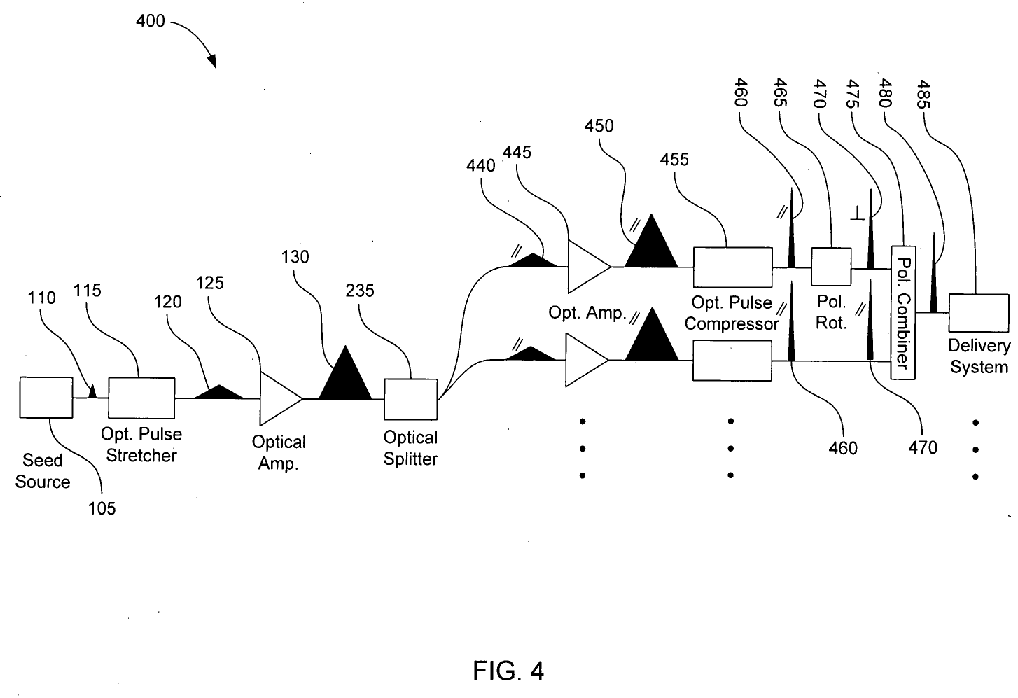

FIG. 4 is a block diagram illustrating yet another embodiment of an optical amplification system 400 including polarization combination, according to various embodiments of the invention. In this embodiment, the optical splitter 235 may optically split the optically amplified chirped optical pulse 130 to produce at least one pair of split optical pulses 440. The polarization of the optically amplified chirped optical pulse 130 may be preserved in the pair of split optical pulses 440. This means that the polarization of the two pulses may be substantially parallel. In FIG. 4, parallel polarization is denoted by the symbol consisting of two parallel lines, “//”.

Since each of the pair of split optical pulses 440 has a reduced power relative to the optically amplified chirped optical pulse 130, the pair of split optical pulses 440 may be further amplified. Subsequent to the optically amplified chirped optical pulse 130 being optically split by the optical splitter 235, each of the pair of split optical pulses 440 may be received by an optical amplifier 445. According to the embodiment illustrated in FIG. 4, the optical amplifiers 445 may include individual optical amplifiers, each being similar to the optical amplifier 125. In another embodiment, the optical amplifiers 445 may each correspond to one of the pulses of the pair of split optical pulses 440. According to various other embodiments, the optical amplifiers 445 may include a single double-clad fiber with multiple cores (e.g., photonic crystal fiber, micro-structured fiber, photonic band gap fiber, holey fiber, or Bragg fiber). According to yet another embodiment, the optical amplifiers 445 may include a single bulk amplifier. The optical amplifiers 445 produce at least one pair of optically amplified split optical pulses 450. Each of the pair of optically amplified split optical pulses 450 may have increased power and similar duration relative to each of the pair of split optical pulses 440.

Following optical amplification by the optical amplifiers 445, each of the pair of optically amplified split optical pulses 450 may be temporally compressed by an optical pulse compressor 455. Each of the optical pulse compressors 455 may include at least one optical pulse compressor similar to the optical pulse compressor 155. A pair of compressed optically amplified split optical pulses 460 may be produced by the optical pulse compressors 455. Each of the pair of compressed optically amplified split optical pulses 460 may have duration similar to the optical pulse 110, but with much higher peak power.

According to various embodiments, a pair of optical pulses may have approximately orthogonal polarization relative to one another to facilitate polarization combination. In the optical amplification system 400, the polarization orientation of one of the pair of compressed optically amplified split optical pulses 460 may be rotated by approximately 90 degrees by a polarization rotator 465. The polarization rotator may include any number of polarization rotating elements (e.g., a ½-wave plate). According to another embodiment, the polarization rotation of one of the pair of compressed optically amplified split optical pulses 460 may be achieved by physically rotating an optical fiber which contains the pulse. A pair of compressed optically amplified split optical pulses 470 results, having approximately orthogonal polarization relative to one another. In FIG. 4, approximately orthogonal polarization is illustrated by attributing the “//” symbol to one of the pulses of the pair of compressed optically amplified split optical pulses 470 and attributing the symbol resembling an inverted “T” to the other.

Subsequent to polarization rotation, the pair of compressed optically amplified split optical pulses 470 may be polarization combined by, for example, a polarization combiner 475. According to various embodiments, the polarization combiner 475 may be fiber-based or a bulk element. The polarization combined pulse 480 may be received by a delivery system 485.

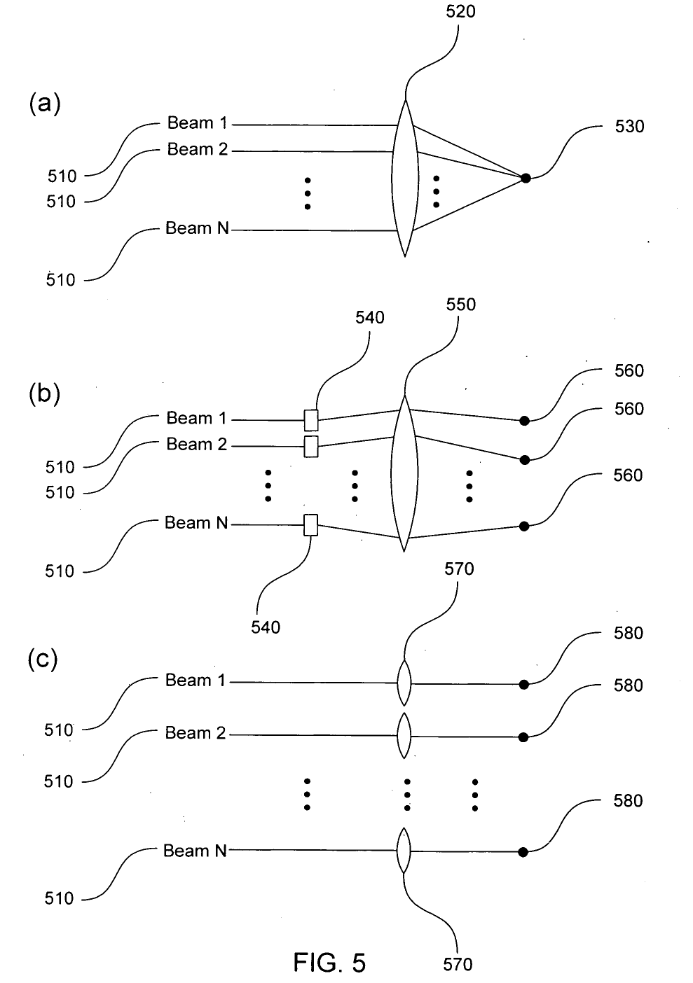

According to various embodiments, a delivery system, such as the delivery system 285, delivery system 385, and delivery system 485, may include any combination of optical fibers, focusing optics, beam modulators, and beam steerers. FIG. 5 is a diagram illustrating a variety of delivery system configurations, according to various embodiments of the invention. The delivery systems 285, 385, and 485 may be configured to focus the plurality of compressed optically amplified split optical pulses to a spot. As illustrated in FIG. 5(a), a plurality of beams 510 may be focused by a lens 520 to a spot 530. The plurality of beams 510 may or may not be synchronized, meaning that the pulses contained in the beams may impinge a target at the same time or at different times.

According to other embodiments, a delivery system, such as the delivery systems 285, 385, and 485, may be configured to focus the plurality of compressed optically amplified split optical pulses to different areas, for example, as illustrated in FIGS. 5(b) and (c). In FIG. 5(b), this may be accomplished by passing the plurality of beams 510 through several independent media 540 which divert the propagation of a beam. According to one embodiment, the independent media 540 may include a glass prism. After being diverted, the lens 550 may focus the plurality of beams 510 to different areas 560.

In yet another embodiment, illustrated in FIG. 5(c), each of the plurality of beams 510 are passed through a corresponding individual lens 570, which may result in the beams being focused to different areas 580. Focusing the plurality of compressed optically amplified split optical pulses to different areas may be a desirable approach, for example, in volume material removal applications. If beams are sufficiently separated, the average power thermal effects may be reduced. In another embodiment, the delivery system configuration 500 may be configured to independently modulate (i.e., turn on and off). According to one embodiment, the delivery system configuration 500 may be configured to independently scan the plurality of compressed optically amplified split optical pulses.

In alternative embodiments, the delivery systems 285, 385, and 485 may include a temporal splitter. The temporal splitter may combine different pulses from, for example, different fibers. As mentioned herein, one skilled in the art will recognize that in some embodiments, the temporal splitter may comprise an acousto-optic switch or a series of binary switches. Additionally, one skilled in the art will further recognize that a spatial or temporal optical splitter may be located at other positions in the optical amplification systems described herein (e.g., between the optical amplifier 345 and the optical pulse compressor 355), in accordance with some embodiments.

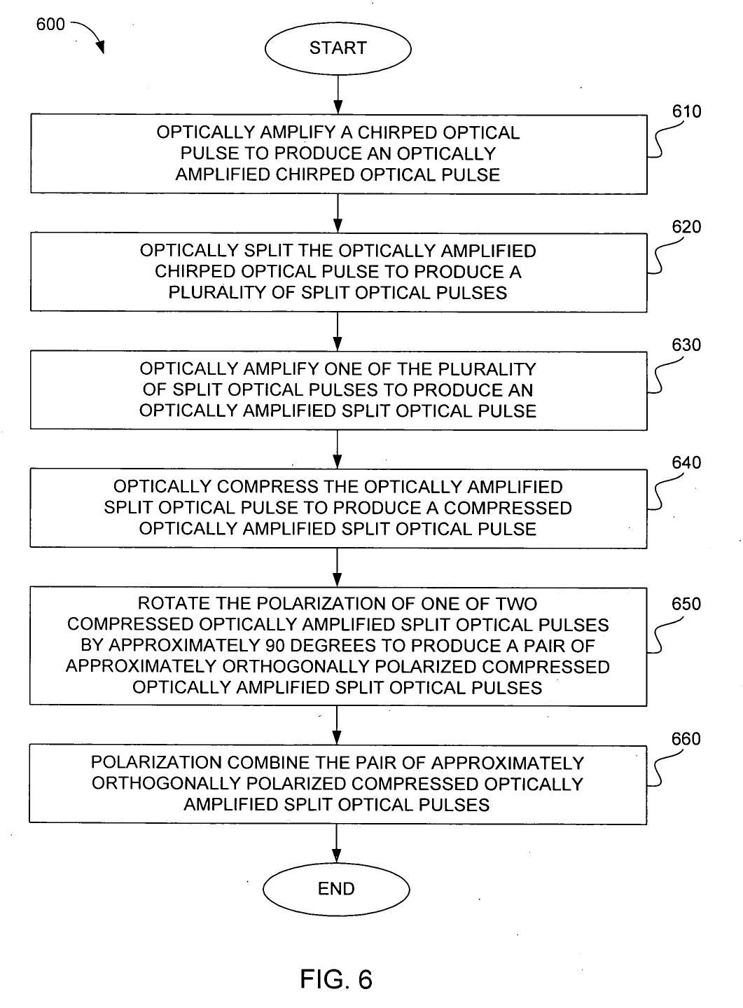

FIG. 6 is a flowchart 600 showing an exemplary process for providing a compressed optically amplified split optical pulse, according to various embodiments of the invention. At step 610, a chirped optical pulse (e.g., the chirped optical pulse 120) is optically amplified to produce an optically amplified chirped optical pulse (e.g., the optically amplified chirped optical pulse 130). As discussed in detail herein, step 610 may be performed by an optical amplifier, such as optical amplifier 125.

At step 620, the optically amplified chirped optical pulse is optically split to produce a plurality of split optical pulses (e.g., the plurality of split optical pulses 240). As discussed in detail herein, step 620 may be performed by an optical splitter, such as the optical splitter 235.

At step 630, at least one of the plurality of split optical pulses is optically amplified to produce an optically amplified split optical pulse (e.g., the optically amplified split optical pulse 250). As discussed in detail herein, step 630 may be performed by an optical amplifier, such as one of the optical amplifiers 245 and the optical amplifier 345.

At step 640, the optically amplified split optical pulse is optically compressed to produce a compressed optically amplified split optical pulse (e.g., the compressed optically amplified split optical pulse 260). As discussed in detail herein, step 640 may be performed by an optical pulse compressor, such as the optical pulse compressor 255 and the optical pulse compressor 355.

At step 650, the polarization of one of two compressed optically amplified split optical pulses is rotated by approximately 90 degrees to produce a pair of approximately orthogonally polarized compressed optically amplified split optical pulses (e.g., the pair of compressed optically amplified split optical pulses 470). As discussed in detail herein, step 650 may be performed by a polarization rotator, such as polarization rotator 465.

At step 660, the pair of approximately orthogonally polarized compressed optically amplified split optical pulses is polarization combined. As discussed in detail herein, step 660 may be performed by a polarization combiner, such as polarization combiner 475.

As mentioned herein, the process shown in the flowchart 600 is exemplary. For example, steps 650 and 660 may be omitted according to some embodiments. In other embodiments, steps may be added which describe certain delivery techniques as may be implemented by delivery systems, such as the delivery systems 285, 385, and 485.

Those skilled in the art would appreciate that waveguides other than optical fibers may be used for some or all components of the optical amplification systems discussed herein. Examples of other waveguides may include planar, or “chip-based,” waveguides. These waveguides may have a substantially rectangular cross-section and allow the same or similar guiding techniques to be utilized as with traditional optical fiber.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A system comprising:
an optical pulse stretcher configured to chirp an optical pulse to produce a chirped optical pulse;
an optical splitter configured to optically split the chirped optical pulse to produce a plurality of split optical pulses;
an optical amplifier configured to optically amplify one of the plurality of split optical pulses to produce an optically amplified split optical pulse; and
an optical pulse compressor configured to compress the optically amplified split optical pulse to produce a compressed optically amplified split optical pulse.

2. The system of claim 1 wherein the optical amplifier comprises an optical fiber.

3. The system of claim 2 wherein the optical fiber has multiple cores.

4. The system of claim 1 wherein the optical amplifier comprises a bulk amplifier.

5. The system of claim 1 wherein the optical amplifier comprises a planar waveguide.

6. The system of claim 1 further comprising a second optical amplifier configured to optically amplify the chirped optical pulse.

7. The system of claim 1 wherein the optical splitter is a temporal splitter.

8. The system of claim 1 wherein the optical pulse compressor comprises a parallel array of individual optical pulse compressors.

9. The system of claim 1 wherein the optical pulse compressor comprises a single bulk grating compressor.

10. The system of claim 1 wherein the optical pulse compressor comprises a single volume Bragg grating.

11. The system of claim 1 further comprising a delivery system configured to deliver a plurality of compressed optically amplified split optical pulses to at least one location.

12. The system of claim 11 wherein the delivery system is further configured to focus the plurality of compressed optically amplified split optical pulses to a spot.

13. The system of claim 11 wherein the delivery system is further configured to focus the plurality of compressed optically amplified split optical pulses to different areas.

14. The system of claim 11 wherein the delivery system is further configured to independently modulate the plurality of compressed optically amplified split optical pulses.

15. The system of claim 11 wherein the delivery system is further configured to independently scan the plurality of compressed optically amplified split optical pulses.

16. The system of claim 1 further comprising a polarization rotator, the polarization rotator configured to rotate the polarization of the compressed optically amplified split optical pulse.

17. The system of claim 1 further comprising a polarization combiner, the polarization combiner configured to combine at least two compressed optically amplified split optical pulses.

18. A method comprising:
optically splitting a chirped optical pulse to produce a plurality of split optical pulses;
optically amplifying one of the plurality of split optical pulses to produce an optically amplified split optical pulse; and
optically compressing the optically amplified split optical pulse to produce a compressed optically amplified split optical pulse.

19. The method of claim 18 further comprising delivering a plurality of compressed optically amplified split optical pulses to at least one location.

20. The method of claim 19 wherein delivering the plurality of compressed optically amplified split optical pulses to at least one location includes focusing the plurality of compressed optically amplified split optical pulses to a spot.

21. The method of claim 19 wherein delivering the plurality of compressed optically amplified split optical pulses to at least one location includes focusing the plurality of compressed optically amplified split optical pulses to different areas.

22. The method of claim 19 wherein delivering the plurality of compressed optically amplified split optical pulses to at least one location includes independently modulating the plurality of compressed optically amplified split optical pulses.

23. The method of claim 19 wherein delivering the plurality of compressed optically amplified split optical pulses to at least one location includes independently scanning the plurality of compressed optically amplified split optical pulses.

24. The method of claim 18 further comprising optically amplifying the chirped optical pulse.

25. The method of claim 18 further comprising:
rotating the polarization of one of two compressed optically amplified split optical pulses by approximately 90 degrees to produce a pair of approximately orthogonally polarized compressed optically amplified split optical pulses; and
polarization combining the pair of approximately orthogonally polarized compressed optically amplified split optical pulses.
